(19) United States
(12) Patent Application Publication
(10) Pub. No.: US 2024/0311643 A1
(43) Pub. Date: Sep. 19, 2024

(54) GENERATING ANALYTICS PREDICTION MACHINE LEARNING MODELS USING TRANSFER LEARNING FOR PRIOR DATA

(71) Applicant: Adobe Inc., San Jose, CA (US)

(72) Inventors: Bowen Wang, Milpitas, CA (US); Yuan Yuan, Sunnyvale, CA (US); Bei Huang, Mountain View, CA (US); Lijing Wang, Menlo Park, CA (US); Yancheng Li, San Jose, CA (US); Jin Xu, Sunnyvale, CA (US); Qilong Yuan, San Jose, CA (US); Zhenyu Yan, Cupertino, CA (US)

(21) Appl. No.: 18/185,828

(22) Filed: Mar. 17, 2023

(51) Int. Cl. G06N 3/096; G06N 3/04

(52) U.S. Cl. CPC G06N 3/096; G06N 3/04

(57) ABSTRACT

The present disclosure relates to systems, methods, and non-transitory computer readable media for generating a modified analytics prediction machine learning model using an iterative transfer learning approach. For example, the disclosed systems generate an initial version of an analytics prediction machine learning model for predicting an analytics metric according to learned parameters. In some embodiments, the disclosed systems determine expected data channel contributions for the analytics metric according to prior data. Additionally, in some cases, the disclosed systems generate a modified analytics prediction machine learning model by iteratively updating model parameters such that predicted data channel contributions are within a threshold similarity of expected data channel contributions.

### BACKGROUND

Recent developments in hardware and software platforms have led to innovations in systems and methods for distributing digital content across computer networks as part of digital content campaigns. For example, media mix modeling (MMM) systems have developed to generate performance predictions for distributing digital content across various content distribution channels. Despite these advances, however, many media mix modeling systems continue to demonstrate a number of deficiencies or drawbacks, particularly in flexibility, accuracy, and efficiency.

### SUMMARY

This disclosure describes one or more embodiments of systems, methods, and non-transitory computer readable media that solve one or more of the foregoing or other problems in the art with systems and methods for generating an analytics prediction machine learning model using a transfer learning approach. For example, the disclosed systems utilize a specialized objective parameter updating process to modify parameters of an analytics prediction machine learning model to leverage a data-driven approach and prior data together. In some embodiments, the disclosed systems update parameters of a trained analytics prediction machine learning model to account for expected data channel contributions together with predicted data channel contributions. For instance, the disclosed systems utilize an iterative update process to adjust model parameters based on expected data channel contributions and predicted data channel contributions (in addition to data-driven model training).

### BRIEF DESCRIPTION OF THE DRAWINGS

This disclosure describes one or more embodiments of the invention with additional specificity and detail by referencing the accompanying figures. The following paragraphs briefly describe those figures, in which:

FIG. 1 illustrates an example system environment in which a transfer learning system operates in accordance with one or more embodiments;

FIG. 2 illustrates an overview of generating and modifying an analytics prediction machine learning model in accordance with one or more embodiments;

FIG. 3 illustrates an example training diagram for building an initial analytics metric machine learning model in accordance with one or more embodiments;

FIG. 4 illustrates an example diagram of an iterative transfer learning process for updating model parameters of an analytics prediction machine learning model in accordance with one or more embodiments;

FIG. 5 illustrates an example diagram for generating an analytics prediction using an analytics prediction machine learning model for informing distribution of digital content as part of a digital content campaign in accordance with one or more embodiments;

FIG. 6 illustrates a schematic diagram of a transfer learning system in accordance with one or more embodiments;

FIG. 7 illustrates a flowchart of a series of acts for generating a modified analytics prediction machine learning model using a transfer learning process in accordance with one or more embodiments

FIG. 8 illustrates a flowchart of a series of acts for generating an analytics metric utilizing an analytics metric machine learning model in accordance with one or more embodiments; and

FIG. 9 illustrates a block diagram of an example computing device in accordance with one or more embodiments.

### DETAILED DESCRIPTION

This disclosure describes one or more embodiments of a transfer learning system that accurately and efficiently generate analytics prediction machine learning models using a transfer learning process that incorporates prior knowledge (e.g., expected data channel contributions) together with data-driven model training. In particular, in some embodiments, the transfer learning system implements a novel parameter learning process to update parameters of an analytics prediction machine learning model to account for expected and predicted data. For instance, the transfer learning system starts by building or training a data-driven analytics prediction machine learning model, and the transfer learning system updates model parameters using an iterative update process that (according to a specialized objective function) incorporates model training data together with data predictions and data expectations based on prior observations. Thus, using an analytics prediction machine learning model that includes parameters learned using the disclosed transfer-learning approach, the transfer learning system generates accurate analytics metrics (e.g., conversion rates) for distribution of digital content as part of a digital content campaign.

As just mentioned, in one or more embodiments, the transfer learning system generates an analytics prediction machine learning model using a transfer learning approach. For example, the transfer learning system starts by building or generating a data-driven model (e.g., an initial version of an analytics prediction machine learning model) and modifies the data-driven model with transfer learning. In some cases, the transfer learning system generates a modified analytics prediction machine learning model by updating initial model parameters, adjusting for prior data such as expected data channel contributions.

For instance, the transfer learning system utilizes an iterative transfer learning process to update model parameters over a number of iterations for different data channels and/or different time periods. Using the iterative process, the transfer learning system further incorporates data expectations and data predictions as part of updating model parameters. Indeed, in some embodiments, the transfer learning system updates model parameters according to a specialized objective function that seeks to reduce (e.g., minimized) the difference between expected data channel contributions and predicted data channel contributions (while also incorporating observed analytics metrics and predicted analytics metrics). Thus, the model parameters that result from the transfer learning process produce data predictions (e.g., predicted data channel contributions) that are within a threshold similarity of expected data (e.g., expected data channel contributions).

Many existing media mix modeling systems are inflexible. To elaborate, some existing systems utilize rigid models with fixed parameter-learning methods that are not adaptable to accommodate prior data, such as expected data channel contributions. Indeed, a problem often arises for existing systems that implement purely data-driven training techniques to learn model parameters, especially when predicted data channel contributions deviate from expected data channel contributions. Specifically, determining data channel contributions involves a complex computation that is not translatable into training guidelines for systems using existing parameter-learning paradigms. Accordingly, many existing media mix modeling systems cannot flexibly adapt model parameters to properly account for (predicted and/or expected) data channel contributions, especially across different contexts (e.g., for different data channels and/or for different digital content campaigns).

Due at least in part to their inflexibility, many existing media mix modeling systems are also inaccurate. Indeed, as mentioned, existing systems cannot accurately generate analytics predictions (e.g., predictions for performance of distributed digital content) that account for expected data channel contributions and predicted data channel contributions together. Such inaccuracies are especially pronounced when applying models trained using prior techniques across different contexts, where such models would ordinarily require retraining model parameters for each new context (a computationally expensive process to repeat for each new application).

As just suggested, some existing media mix modeling systems are inefficient. To elaborate, some prior systems have used computationally expensive techniques in attempts to incorporate expected data channel contributions and predicted data channel contributions together. For example, existing systems often require retraining model parameters for each new set of data channels and/or for each new digital content campaign, which consumes excessive amounts of processing power and memory. In addition, some prior systems must increase model complexity by introducing additional hyperparameters to account for expected data channel contributions. Such increases in model complexity are often significant and thus result in greatly increased parameter spaces when generating predictions, thereby increasing the computational expense for both training and implementing these models. Other existing systems apply constraints in the training process (e.g., by bounding coefficient estimates in a regression setting) to account for expected data channel contributions. However, without more sophisticated parameter updating, setting such constraints often takes trial and error to calibrate properly, which process consumes excessive computing resources in testing and retesting resulting predictions.

As suggested above, embodiments of the transfer learning system provide certain improvements or advantages over conventional media mix modeling systems. For example, embodiments of the transfer learning system improve flexibility over many existing systems. To elaborate, unlike to existing systems that are purely data-driven, some embodiments of the transfer learning system utilize a novel parameter-learning technique that incorporates prior data (e.g., expected data channel contributions) together with a data-driven approach to model training, even for situations where expected data channel contributions deviate from predicted data channel contributions. For example, the transfer learning system utilizes an iterative parameter update process that flexibly adapts to different contexts (e.g., different data channels and/or different digital content campaigns) without retraining by implementing a specialized, iterative parameter update process which (according to its objective function) accounts for expected data channel contributions, predicted data channel contributions, predicted analytics metrics, and observed analytics metrics.

Due at least in part to improving flexibility over prior systems, some embodiments of the transfer learning system also improve accuracy over prior media mix modeling systems. While some existing systems generate models that inaccurately (or that cannot) account for prior data such as expected data channel contributions, the transfer learning system generates an analytics prediction machine learning model utilizing a unique parameter learning process that accurately incorporates expected data channel contributions together with predicted data channel contributions. By properly accounting for expected and predicted data channel contributions, the transfer learning system generates analytics prediction machine learning models that more accurately predict analytics metrics (e.g., conversions) for distributed digital content. In addition, using its iterative update process, the transfer learning system further adapts a trained analytics prediction machine learning model across contexts/domains for accurate predictions by updating model parameters without needing to entirely retrain the model (thus also saving computing resources).

As just suggested, some embodiments of the transfer learning system further improve efficiency of prior media mix modeling systems. For example, the transfer learning system circumvents the need to retrain an analytics prediction machine learning model for each new context/domain (e.g., for different data distribution channels and/or for different digital content campaigns), thereby saving processing power and memory compared to prior systems that require such context-specific retraining. In addition, by using its novel iterative parameter update process, the transfer learning system improves efficiency (in training and implementation) over some prior systems that increase model complexity by introducing additional hyperparameters. Further, as opposed to existing systems that apply bounding coefficients or other constraints that lead to a trial-and-error training process, the transfer learning system utilizes a specialized iterative parameter update process for increased speed and efficiency.

As suggested by the foregoing discussion, this disclosure utilizes a variety of terms to describe features and benefits of the transfer learning system. Additional detail is hereafter provided regarding the meaning of these terms as used in this disclosure. In particular, the term “analytics metric” refers to a metric, an activity, or a set of activities that results from distributing digital content as part of a digital content campaign and/or that is the aim of a digital content campaign. For example, an analytics metric includes a conversion, a number of units sold, a measure of revenue, an aggregate level, or a click-through rate. An analytics metric is sometimes time-based and determined or predicted on an hourly, daily, weekly, or monthly basis. In some cases, the transfer learning system generates or determines predicted analytics metrics, observed analytics metrics, and/or target analytics metric. A predicted analytics metric includes an analytics metric predicted by an analytics prediction machine learning model. An observed analytics metric includes an analytics metric determined or observed as a result of distributing digital content as part of a digital content campaign. A target analytics metric includes an analytics metric that is designated as the aim or purpose of a digital content campaign.

In addition, the term “data channel” refers to a channel or dimension for distributing and collecting data regarding digital content as part of a digital content campaign. For example, a data channel includes a category or type of digital content distributed to client devices (e.g., emails, website content banners, social media content banners, search result links, and social media searches) for triggering analytics metrics (e.g., based on interactions from the client devices). Relatedly, the term “data channel contribution” refers to a contribution apportionment attributed to a particular data channel for achieving an analytics metric. For instance, the transfer learning system determines three different data channel contributions for achieving an analytics metric via a digital content campaign that distributes digital content across three data different channels. Relatedly, an “expected data channel contribution” refers to a data channel contribution that is expected for a data channel based on prior observed data (e.g., contributions observed from previous experiments and/or for a previous digital content campaign or contributions expected based on volume of digital content distributed per data channel). Along these lines, a “predicted data channel contribution” refers to a data channel contribution that is predicted using a data channel contribution function.

As used herein, the term “data channel contribution function” refers to a function, algorithm, or process that is executable by one or more computer processors to determine a data channel contribution based on a set of model parameters. For instance, a data channel contribution function includes variables and/or constituent functions that are determinable based on model parameters of an analytics prediction machine learning model. In some cases, the transfer learning system utilizes a surrogate function as a modified form of an objective function with substitute terms for data channel contribution. As used herein, the term “surrogate function” refers to a function, algorithm, or process that replaces, substitutes, or stands in for another function. For instance, a surrogate function includes a function that is similar to an objective function or a data channel contribution function but that includes substitute terms that are definable based on observed data.

As used herein, the term “digital content provider” refers to an entity that provides or distributes digital content to one or more target entities or client devices. For example, a digital content provider includes one or more servers managed by a company or organization to provide digital content to for achieving an analytics metric. Such “digital content” includes, but is not limited to, emails, website banners or other website content, posts or messages within social media platforms, and/or video segments provided via online streaming services with the aim of achieving an analytics metric.

As mentioned above, the transfer learning system utilizes a transfer learning process to generate analytics prediction machine learning models. As used herein, the term “machine learning model” refers to a computer algorithm or a collection of computer algorithms that automatically improve for a particular task through experience based on use of data. For example, a machine learning model utilizes one or more learning techniques to improve in accuracy and/or effectiveness. Example machine learning models include various types of neural networks, decision trees, support vector machines, and Bayesian networks.

As mentioned above, the transfer learning system utilizes machine learning models in the form of neural networks in one or more implementations. As used herein, the term “neural network” refers to a machine learning model that is trainable and/or tunable based on inputs to determine classifications or approximate unknown functions. For example, a neural network includes a model of interconnected artificial neurons (e.g., organized in layers) that communicate and learn to approximate complex functions and generate outputs (e.g., predicted analytics metrics) based on a plurality of inputs provided to the neural network. In some cases, a neural network refers to an algorithm (or set of algorithms) that implements deep learning techniques to model high-level abstractions in data. For example, a neural network includes, in one or more implementations, a convolutional neural network, a recurrent neural network (e.g., an LSTM), a graph neural network, or a generative adversarial neural network.

In some embodiments, the transfer learning system trains, builds, or generates an analytics prediction machine learning model. As used herein, the term “analytics prediction machine learning model” refers to a machine learning model (e.g., a neural network) that generates predicted analytics metrics according to learned model parameters. For example, an analytics prediction machine learning model includes a machine learning model that, according to its parameters, generates an analytics prediction based on content distribution data for a digital content campaign.

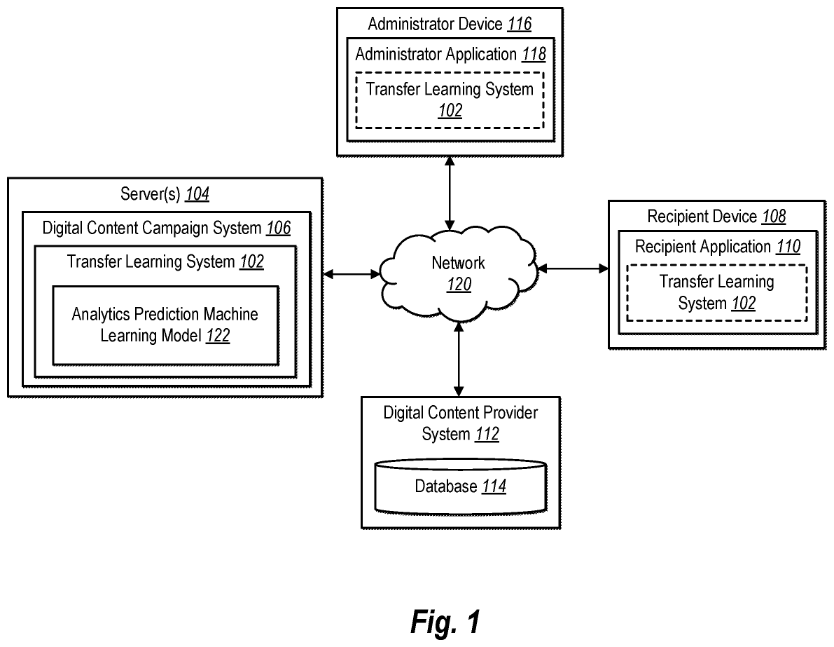

Additional detail regarding the transfer learning system will now be provided with reference to the figures. For example, FIG. 1 illustrates a schematic diagram of an example system environment for implementing a transfer learning system 102 in accordance with one or more embodiments. An overview of the transfer learning system 102 is described in relation to FIG. 1. Thereafter, a more detailed description of the components and processes of the transfer learning system 102 is provided in relation to the subsequent figures.

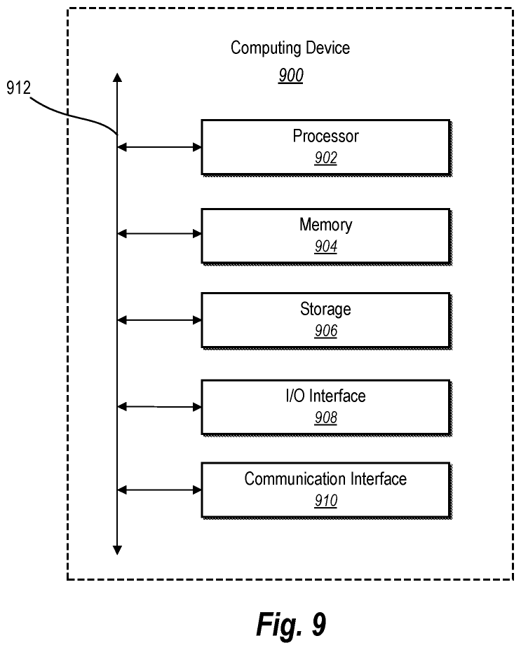

As shown, the environment includes server(s) 104, a recipient device 108, an administrator device 116, a digital content provider system 112, and a network 120. Each of the components of the environment communicate via the network 120, and the network 120 is any suitable network over which computing devices communicate. Example networks are discussed in more detail below in relation to FIG. 9.

As mentioned, the environment includes a recipient device 108. The recipient device 108 is one of a variety of computing devices, including a smartphone, a tablet, a smart television, a desktop computer, a laptop computer, a virtual reality device, an augmented reality device, or another computing device as described in relation to FIG. 9. Although FIG. 1 illustrates a single instance of the recipient device 108, in some embodiments, the environment includes multiple different recipient devices, each associated with a different user. The recipient device 108 communicates with the server(s) 104 and/or the digital content provider system 112 via the network 120. For example, the recipient device 108 receives digital content from the digital content provider system 112 and provides information to server(s) 104 indicating client device interactions (e.g., views, clicks, or other input) with respect to the digital content (e.g., for use in training an analytics prediction machine learning model and/or generating an analytics prediction using an analytics prediction machine learning model). Thus, the transfer learning system 102 on the server(s) 104 receives information based on client device interaction via the recipient device 108.

As shown in FIG. 1, the recipient device 108 includes a recipient application 110. In particular, the recipient application 110 is a web application, a native application installed on the recipient device 108 (e.g., a mobile application or a desktop application), or a cloud-based application where all or part of the functionality is performed by the server(s) 104. The recipient application 110 presents or displays information to a user, including digital content provided as part of a digital content campaign.

As mentioned above, the environment includes an administrator device 116. The administrator device 116 is one of a variety of computing devices, including a smartphone, a tablet, a smart television, a desktop computer, a laptop computer, a virtual reality device, an augmented reality device, or another computing device as described in relation to FIG. 9. Although FIG. 1 illustrates a single instance of the administrator device 116, in some embodiments, the environment includes multiple different administrator devices, each associated with a different user (e.g., an administrator). The administrator device 116 communicates with the server(s) 104 via the network 120. For example, the administrator device 116 receives data from the server(s) 104 to display a user interface for training an analytics prediction machine learning model 122 and/or arranging a digital content campaign (e.g., via the administrator application 118). The administrator device 116 further provides data to the server(s) 104 in the form of user input via the administrator application 118. Thus, the transfer learning system 102 on the server(s) 104 receives information based on client device interaction via the administrator device 116.

As shown in FIG. 1, the administrator device 116 includes an administrator application 118. In particular, the administrator application 118 is a web application, a native application installed on the administrator device 116 (e.g., a mobile application, a desktop application, etc.), or a cloud-based application where all or part of the functionality is performed by the server(s) 104. The administrator application 118 presents or displays information to an administrator, including a model training interface and/or a digital content campaign interface.

As further illustrated in FIG. 1, the environment includes a digital content provider system 112. In particular, the digital content provider system 112 generates, provides, and/or distributes digital content to target entities (e.g., to the recipient device 108) according to one or more predicted analytics metrics generated by an analytics prediction machine learning model 122. For example, the digital content provider system 112 communicates with the server(s) 104 and/or the administrator device 116 to identify or determine digital content to provide to particular digital profiles or recipient devices associated with a target entity (e.g., according to an analytics metric predicted by the analytics prediction machine learning model 122). In some cases, the digital content provider system 112 utilizes a database 114 to store or maintain digital content for distribution to target entities.

As illustrated in FIG. 1, the environment includes the server(s) 104. The server(s) 104 generates, tracks, stores, processes, receives, and transmits electronic data, such as model parameters, content distribution data, observed data, expected data channel contributions, and analytics metrics. For example, the server(s) 104 receives data from the recipient device 108 in the form of an indication of a client device interaction to view digital content provided by the digital content provider system 112. In response, the server(s) 104 receives data indicating interactions with digital content items as part of a digital content campaign and/or for training or updating an analytics prediction machine learning model 122.

In some embodiments, the server(s) 104 communicates with the recipient device 108 and/or the administrator device 116 to transmit and/or receive data via the network 120. In some embodiments, the server(s) 104 comprises a distributed server where the server(s) 104 includes a number of server devices distributed across the network 120 and located in different physical locations. The server(s) 104 comprise a content server, an application server, a communication server, a web-hosting server, a multidimensional server, or a machine learning server.

As further shown in FIG. 1, the server(s) 104 also includes the transfer learning system 102 as part of a digital content campaign system 106. For example, in one or more implementations, the digital content campaign system 106 stores, generates, modifies, edits, enhances, provides, distributes, and/or shares digital content, such as digital images, emails, or digital videos. For example, the digital content campaign system 106 provides digital content as part of a digital content campaign for motivating a particular target entity to perform a conversion activity. In some implementations, the digital content campaign system 106 provides specific digital content to particular digital profiles associated with recipient devices (e.g., the recipient device 108).

In one or more embodiments, the server(s) 104 includes all, or a portion of, the transfer learning system 102. For example, the transfer learning system 102 operates on the server(s) 104 to generate and update an analytics prediction machine learning model 122. In certain cases, the recipient device 108 and/or the administrator device 116 includes all or part of the transfer learning system 102. For example, the recipient device 108 and/or the administrator device 116 generates, obtains (e.g., download), or utilizes one or more aspects of the transfer learning system 102, such as the analytics prediction machine learning model 122 from the server(s) 104. Indeed, in some implementations, as illustrated in FIG. 1, the transfer learning system 102 is located in whole or in part of the recipient device 108 and/or the administrator device 116. For example, the transfer learning system 102 includes a web hosting application that allows the recipient device 108 and/or the administrator device 116 to interact with the server(s) 104. To illustrate, in one or more implementations, the recipient device 108 and/or the administrator device 116 accesses a web page supported and/or hosted by the server(s) 104.

In one or more embodiments, the administrator device 116, the recipient device 108, and the server(s) 104 work together to implement the transfer learning system 102. For example, in some embodiments, the server(s) 104 train one or more neural networks discussed herein and provide the one or more neural networks to the administrator device 116 and/or the recipient device 108 for implementation. In some embodiments, the server(s) 104 trains one or more neural networks together with the administrator device 116 and/or the recipient device 108.

Although FIG. 1 illustrates a particular arrangement of the environment, in some embodiments, the environment has a different arrangement of components and/or may have a different number or set of components altogether. For instance, as mentioned, the transfer learning system 102 is implemented by (e.g., located entirely or in part on) the recipient device 108 and/or the administrator device 116. In addition, in one or more embodiments, the recipient device 108 and/or the administrator device 116 communicates directly with the transfer learning system 102, bypassing the network 120.

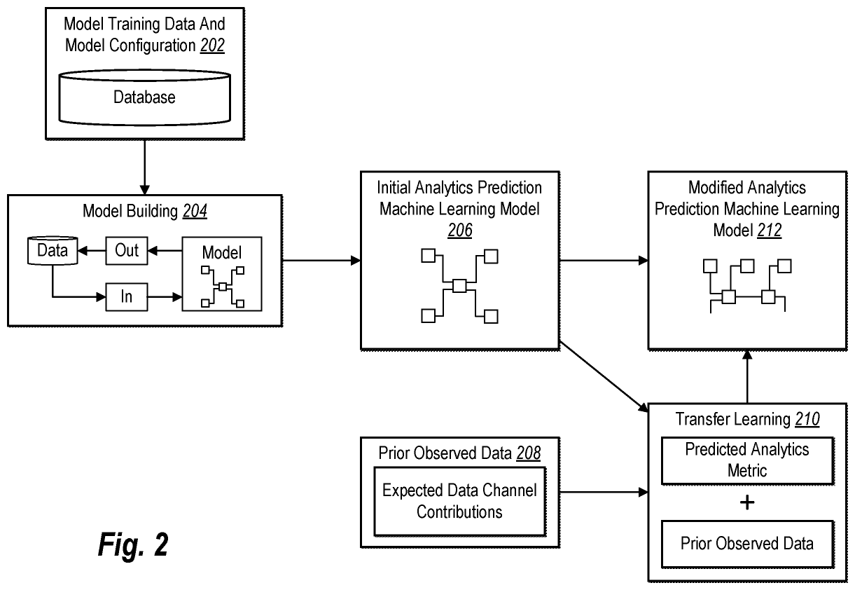

As mentioned, in one or more embodiments, the transfer learning system 102 generates and updates an analytics prediction machine learning model utilizing a transfer learning process. In particular, the transfer learning system 102 iteratively updates parameters of an analytics prediction machine learning model based on prior data or expectations. FIG. 2 illustrates an overview diagram for generating a modified analytics prediction machine learning model in accordance with one or more embodiments. Additional detail regarding the various acts or components described in relation to FIG. 2 is provided thereafter with reference to subsequent figures.

As illustrated in FIG. 2, the transfer learning system 102 accesses initialization data 202 for initializing an analytics prediction machine learning model. For instance, the initialization data 202 includes model training data and model configuration data that are used for building an initial version of an analytics prediction machine learning model. Indeed, as shown, the transfer learning system 102 performs a model building process 204 to generate or train an initial (e.g., data-driven) version of an analytics prediction machine learning model. To elaborate, the transfer learning system 102 accesses a database (e.g., the database 114) storing model training data and/or model configuration data. For instance, the transfer learning system 102 accesses model training data that includes sample digital content, target audience classes and/or target audience data (e.g., demographic data including age data, gender data, location data, and device data), and ground truth analytics metrics that correspond to the sample digital content and/or target audience classes/data. Using the model training data, the transfer learning system 102 learns initial parameters for an analytics prediction machine learning model.

In addition to model training data, the transfer learning system 102 accesses model configuration data. Indeed, the transfer learning system 102 determines, from the model configuration data, a number of training iterations (or a training threshold for accuracy to trigger termination of the training process), a model architecture for the analytics prediction machine learning model, and/or other configurable aspects of the analytics prediction machine learning model. Based on the model configuration data and the model training data, the transfer learning system 102 generates an initial analytics prediction machine learning model 206 that includes an initial set of parameters learned (via the model building process 204) according to the initialization data 202.

As further illustrated in FIG. 2, the transfer learning system 102 utilizes a transfer learning process 210 to modify or update parameters of the initial analytics prediction machine learning model 206. To elaborate, the transfer learning system 102 utilizes the transfer learning process 210 to modify the initial analytics prediction machine learning model 206 utilizing prior observed data 208. In some cases, the transfer learning system 102 determines or accesses expected data channel contributions from the prior observed data 208. For example, the transfer learning system 102 determines what results (e.g., analytics metrics) to expect from digital content distributed via various data channels, as indicated by the prior observed data 208 (e.g., from previous digital content campaigns that distributed digital content using the same data channels and/or to similar audiences). The transfer learning system 102 further utilizes the expected data channel contributions as a data prior to adjust model parameters via the transfer learning process 210.

As shown, the transfer learning system 102 performs the transfer learning process 210 to generate a modified analytics prediction machine learning model 212 by iteratively updating parameters of the initial analytics prediction machine learning model 206. Specifically, the transfer learning system 102 performs multiple update iterations to adjust model parameters to account for predicted analytics metrics and the prior observed data 208 (e.g., according to a transfer learning objective function). In some cases, the transfer learning system 102 updates model parameters to generate parameters that (when used in a data channel contribution function) produce predicted data channel contributions that are within a threshold similarity of the expected data channel contributions (of the prior observed data 208).

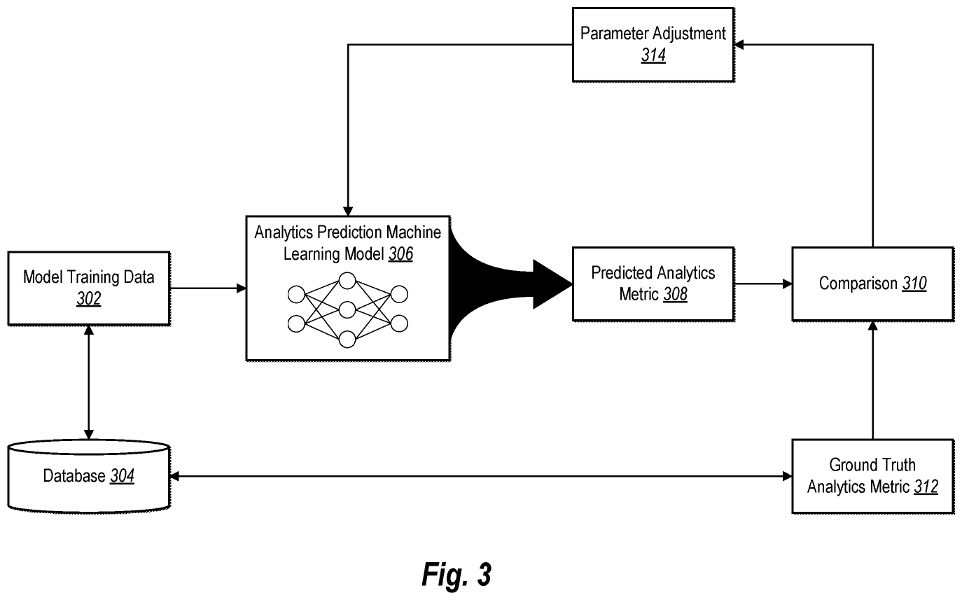

As mentioned above, in certain described embodiments, the transfer learning system 102 generates an initial version of an analytics prediction machine learning model. In particular, the transfer learning system 102 trains an analytics prediction machine learning model by using a data-driven approach to learn an initial set of parameters according to model training data. FIG. 3 illustrates an example training diagram for generating an initial analytics prediction machine learning model in accordance with one or more embodiments.

As illustrated in FIG. 3, the transfer learning system 102 accesses model training data 302 from a database 304 (e.g., the database 114). More specifically, the transfer learning system 102 accesses sample digital content and/or sample audience data to input into the analytics prediction machine learning model 306. Based on the sample digital content and/or the sample audience data, the analytics prediction machine learning model 306 generates a predicted analytics metric 308. For instance, the analytics prediction machine learning model 306 generates the predicted analytics metric 308 in the form of a conversion rate that will result from distributing sample digital content to a sample audience with the sample audience data.

As further illustrated in FIG. 3, the transfer learning system 102 performs a comparison 310. In particular, the transfer learning system 102 compares the predicted analytics metric 308 with a ground truth analytics metric 312 accessed from the database 304 and designated as corresponding to the model training data 302. To perform the comparison 310, in some embodiments, the transfer learning system 102 utilizes a loss function such as a mean square error loss function or a cross entropy loss function (or some other loss function based on the architecture of the analytics prediction machine learning model 306) to determine a measure of loss between the predicted analytics metric 308 and the ground truth analytics metric 312.

Based on the comparison 310, the transfer learning system 102 further performs a parameter adjustment 314. For example, the transfer learning system 102 performs the parameter adjustment 314 to adjust or modify parameters of the analytics prediction machine learning model 306 according to the comparison 310 (e.g., to reduce a measure of loss). In cases with the analytics prediction machine learning model 306 is a neural network, the transfer learning system 102 back propagates to modify internal parameters of the analytics prediction machine learning model 306, such as weights and biases corresponding to internal layers and neurons of the model. By modifying the parameters, the transfer learning system 102 adjusts how the analytics prediction machine learning model 306 processes and passes information to reduce a measure of loss (as determined via the comparison 310) for subsequent iterations.

Indeed, the transfer learning system 102 repeats the process illustrated in FIG. 3 for multiple iterations or epochs and/or until the analytics prediction machine learning model 306 generates a predicted analytics metric that satisfies a threshold measure of loss (or a threshold accuracy) and/or for a defined number of iterations. For instance, for each iteration, the transfer learning system 102: i) accesses model training data, ii) utilizes the analytics prediction machine learning model 306 to generate a predicted analytics metric from the training data, iii) compares (via a loss function) the predicted analytics metric with a corresponding ground truth analytics metric, and iv) adjusts parameters to reduce the measure of loss associated with the analytics prediction machine learning model 306.

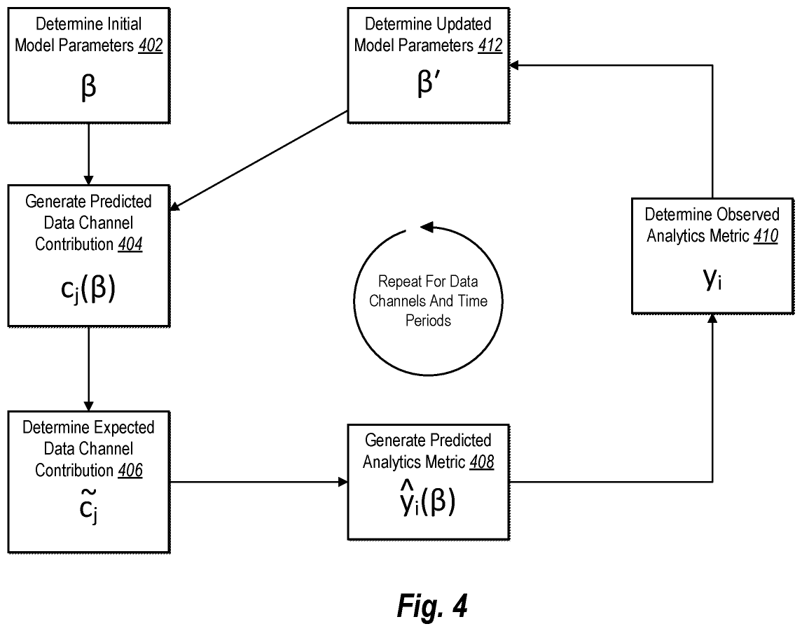

As mentioned, in certain described embodiments, the transfer learning system 102 generates a modified analytics prediction machine learning model from an initial version of the analytics prediction machine learning model. In particular, the transfer learning system 102 utilizes a transfer learning process to iteratively update model parameters according to predicted and expected data channel contributions. FIG. 4 illustrates an example diagram for iteratively updating parameters of an analytics prediction machine learning model using transfer learning in accordance with one or more embodiments.

As illustrated in FIG. 4, the transfer learning system 102 performs an act 402 to determine initial model parameters. More specifically, the transfer learning system 102 generates or trains an initial version of an analytics prediction machine learning model, as described above. Accordingly, the transfer learning system 102 determines initial model parameters from the initial model training process. As shown, the model parameters are represented by β.

As further illustrated in FIG. 4, the transfer learning system 102 performs an iterative process to update the model parameters to more accurately track or incorporate both predicted and expected data channel contributions as part of ultimately predicting analytics metrics from the parameters (e.g., via the analytics prediction machine learning model). Indeed, the transfer learning system 102 iterates through a number of acts shown in FIG. 4 for different data channels (represented by j) and for different time periods (represented by i). The transfer learning system 102 thus repeats the iterative process until the model parameters reflect or incorporate data channel contributions (along with predicted and observed analytics metrics) for a set of data channels and/or a set of time periods. For example, the transfer learning system 102 repeats the iterative process to reduce or minimize the different between predicted data channel contributions and expected data channel contributions, as directed by the following transfer learning objective function:

$$min β {\sum }_{j = 0}^{g} {( {c}_{j} ( β ) - {\tilde{c}}_{j} )}^{2} + λ {\sum }_{i = 1}^{n} {( {\hat{y}}_{i} ( β ) - {y}_{i} )}^{2}$$

where β represents the parameters of the analytics prediction machine learning model, j represents a data channel, i represents a time period, cⱼ(β) represents a predicted data channel contribution for data channel j, \tilde{c}ⱼ represents an expected data channel contribution for data channel j, ŷᵢ(β) represents a predicted analytics metric (e.g., from an analytics prediction machine learning model) for time period i, yᵢ represents an observed analytics metric for time period i, and λ represents a non-negative hyperparameter to ensure that model fit is not comprised as a result of moving closer expected data channel contributions. In the above transfer learning objective function, the first summation represents the distance or difference between the predicted and expected market contributions. The second summation represents model goodness-of-fit. In some embodiments, the transfer learning system 102 utilizes initial parameters β₀ (e.g., parameters from the purely data-driven version of the model) as initial values of the transfer learning optimization problem/objective function.

As part of the iterative parameter update process, the transfer learning system 102 performs an act 404 to generate a predicted data channel contribution for a specific data channel. In particular, the transfer learning system 102 generates a predicted data channel contribution by utilizing a data channel contribution function. The transfer learning system 102 utilizes the data channel contribution function to determine or predict a measure of contribution to attribute to a particular data channel j in impacting or causing an analytics metric (e.g., as part of a digital content campaign). In some cases, the transfer learning system 102 generates the predicted data channel contribution for the particular data channel j over a particular time period (or time window) i. For instance, the transfer learning system 102 generates a predicted data channel contribution according to the following data channel contribution function:

$${c}_{j} ( β ) = \frac{{Σ}_{i = 1}^{n} {s}_{i , j} ( β )}{{Σ}_{i = 1}^{n} {\hat{y}}_{i} ( β )}$$

where cⱼ(β) represents the predicted data channel contribution, i represents a time period, j represents a data channel, s_{i,j}(β) represents the predicted contribution of data channel j over time period i toward achieving an analytics metric, and ŷᵢ(β) represents the model-predicted analytics metric for time period i.

As mentioned above, in one or more embodiments, the transfer learning system 102 generates and utilizes a surrogate function to substitute for the transfer learning objective function. Indeed, to improve real-world application and implementation of the objective function for updating model parameters, the transfer learning system 102 generates a surrogate function that replaces terms for predicted analytics metrics (ŷᵢ(β), as generated by an analytics prediction machine learning model) with terms for observed analytics metrics (yᵢ). By substituting predicted terms with observed terms, the transfer learning system 102 solves the problem of relying on data out of sequence, where predictions based on the parameters being updated would otherwise be part of determining how to update the parameters. To generate or determine the surrogate function, in some cases, the transfer learning system 102 defines s_{i,j}(β) according to the following:

$${s}_{i , 0} ( β ) = {β}_{0} {\prod }_{k ∈ {C}_{0}} {X}_{i , k}^{{β}_{k}}$$

$$and {s}_{i , j} ( β ) = ( {\hat{y}}_{i} ( β ) - {s}_{i , 0} ) \times \frac{{\sum }_{k ∈ {C}_{j}} {β}_{k} log ( {X}_{i , k} )}{{\sum }_{j = 1}^{g} {\sum }_{k ∈ {C}_{j}} {β}_{k} log ( {X}_{i , k} )} for j > 0$$

where βₖ represents the model parameters indexed by [k=0, . . . , K], β₀ represents an intercept term of the model parameters (where k=0), X represents a design matrix, Cⱼ represents a set of column indices for the design matrix X, and where the other terms are as defined above.

To generate the surrogate function, the transfer learning system 102 substitutes the equations for cⱼ(β), s_{i,0}(β), and s_{i,j}(β) into the transfer learning objective function defined above. Accordingly, the transfer learning system 102 generates a surrogate function in the following form:

$${min}_{β} {( \frac{{Σ}_{i = 1}^{n} {β}_{0} {Π}_{k ∈ {C}_{0}} {X}_{i , k}^{{β}_{k}}}{{Σ}_{i = 1}^{n} {\hat{y}}_{i} ( β )} - {\tilde{c}}_{0} )}^{2} + {\sum }_{j = 1}^{g} {( \frac{{Σ}_{i = 1}^{n} ( {\hat{y}}_{i} ( β ) - {β}_{0} {Π}_{k ∈ {C}_{0}} {X}_{i , k}^{{β}_{k}} ) \times \frac{{Σ}_{k ∈ {C}_{j}} {β}_{k} log ( {X}_{i , k} )}{{Σ}_{j = 1}^{g} {Σ}_{k ∈ {C}_{j}} {β}_{k} log ( {X}_{i , k} )}}{{Σ}_{i = 1}^{n} {\hat{y}}_{i} ( β )} - {\tilde{c}}_{j} )}^{2} + λ {\sum }_{i = 1}^{n} {( {\hat{y}}_{i} ( β ) - {y}_{i} )}^{2}$$

where the terms are as defined above.

As shown above, this initial version of the surrogate function depends on predicted analytics metrics, ŷᵢ(β), in several places for updating model parameters, specifically through the data channel contribution function cⱼ(β). In some embodiments, the transfer learning system 102 thus modifies the surrogate function (or generates a final surrogate function) by replacing or substituting the predicted analytics metrics, ŷᵢ(β), with observed analytics metrics yᵢ. Accordingly, the transfer learning system 102 generates the following surrogate function to utilize for updating model parameters:

$${min}_{β} {( \frac{{Σ}_{i = 1}^{n} {β}_{0} {Π}_{k ∈ {C}_{0}} {X}_{i , k}^{{β}_{k}}}{{Σ}_{i = 1}^{n} {y}_{i}} - {\tilde{c}}_{0} )}^{2} + {\sum }_{j = 1}^{g} {( \frac{{Σ}_{i = 1}^{n} ( {y}_{i} - {β}_{0} {Π}_{k ∈ {C}_{0}} {X}_{i , k}^{{β}_{k}} ) \times \frac{{Σ}_{k ∈ {C}_{j}} {β}_{k} log ( {X}_{i , k} )}{{Σ}_{j = 1}^{g} {Σ}_{k ∈ {C}_{j}} {β}_{k} log ( {X}_{i , k} )}}{{Σ}_{i = 1}^{n} {y}_{i}} - {\tilde{c}}_{j} )}^{2} + λ {\sum }_{i = 1}^{n} {( {\hat{y}}_{i} ( β ) - {y}_{i} )}^{2}$$

In some cases, the transfer learning system 102 performs the substitutions for more tractable gradient computation using appropriately calibrated λ hyperparameters.

As further illustrated in FIG. 4, the transfer learning system 102 performs an act 406 to determine an expected data channel contribution, \tilde{c}ⱼ. Indeed, the transfer learning system 102 determines an expected data channel contribution from prior observed data. For example, the transfer learning system 102 determines an expected data channel contribution based on previously determined contributions for data channels of prior digital content campaigns. In certain embodiments, the transfer learning system 102 determines an expected data channel contribution for the data channel j based on contributions of the data channel j as used to distribute digital content to achieve a particular analytics metric as part of a prior digital content campaign. In some cases, the transfer learning system 102 receives an indication of an expected data channel contribution from the administrator device 116 that designates expectations based on previous digital content campaigns.

In addition, the transfer learning system 102 performs an act 408 to generate a predicted analytics metric, ŷᵢ(β). More particularly, the transfer learning system 102 generates a predicted analytics metric from the current iteration of the model parameters by applying an analytics prediction machine learning model that includes the model parameters. For example, the transfer learning system 102 generates a modified analytics prediction machine learning model that includes the updated parameters. In some cases, the modified analytics prediction machine learning model is given by the following representation:

$${\hat{y}}_{i} ( β ) = {β}_{0} {\prod }_{j = 0}^{g} {\prod }_{k ∈ {C}_{j}} {X}_{i , k}^{{β}_{k}}$$

where, as indicated above, Cⱼ represents the set of columns of design matrix X that corresponds to data channel j (there is sometimes more than one index from each data channel due to ad-stock transformations). In some embodiments, the {Cⱼ}s form a partition of the column indices of X, and β=[β₀, β_{C}_{ₒ}, . . . , β_{C}_{_{g}}]. To avoid confusion in notation, X has columns k=1, . . . , K and β is indexed by k=0, . . . , K where β₀ represents the intercept term. In some cases, the data channel j=0 represents a baseline data channel while j=1, . . . , g represent data channels 1 through g, respectively.

As further illustrated in FIG. 4, the transfer learning system 102 performs an act 410 to determine an observed analytics metric, yᵢ. In particular, the transfer learning system 102 determines an observed analytics metric from actual results of a digital content campaign. For example, the transfer learning system 102 accesses a database that indicates observed analytics metrics, such as conversion rates, revenue, or others, that result from distributing digital content for time period i as part of a digital content campaign. In some cases, the transfer learning system 102 determines the observed analytics metric by receiving an indication of the observed analytics metric from the administrator device 116 that indicates observations or actual results from a digital content campaign.

Additionally, the transfer learning system 102 performs an act 412 to determine updated model parameters. More specifically, the transfer learning system 102 generates a modified analytics prediction machine learning model by updating the parameters according to the predicted data channel contribution, the expected data channel contribution, the predicted analytics metric, and the observed analytics metric. In some cases, the transfer learning system 102 updates the model parameters to reduce a difference between predicted data channel contributions and expected data channel contributions.

For instance, the transfer learning system 102 generates, from the parameters, a point in multidimensional parameter space that represents a predicted data channel contribution. Specifically, the transfer learning system 102 utilizes the data channel contribution function, cⱼ(β) as described above, to determine a point in parameter space that represents the predicted data channel contributions as defined by the parameters β. In addition, the transfer learning system 102 determines an additional point in the parameter space that represents the expected data channel contributions \tilde{c}ⱼ. The transfer learning system 102 compares the point representing the predicted contributions and the additional point representing the expected contributions to determine a distance between them in the parameter space. Accordingly, the transfer learning system 102 repeats the iterative process of FIG. 4 to update the model parameters until the distance between the points in the parameter space (e.g., the predicted point and the expected point) are within a threshold distance of each other (thus satisfying a threshold similarity). Indeed, in some cases, the transfer learning system 102 uses the transfer learning objective function (or the surrogate function) to reduce or minimize the distance.

Similarly, in some embodiments, the transfer learning system 102 compares predicted and observed analytics metrics. Specifically, the transfer learning system 102 utilizes an analytics prediction machine learning model to generate a point in parameter space representing a predicted analytics metric, as given by ŷᵢ(β). Additionally, the transfer learning system 102 determines or identifies another point in the parameter space representing an observed analytics metric, yᵢ. In some cases, the transfer learning system 102 further compares the point for the predicted analytics metric with the point for the observed analytics metric. For instance, the transfer learning system 102 determines a distance between the points. Accordingly, the transfer learning system 102 utilizes the iterative process (defined by the objective/surrogate function) to update parameters of the analytics prediction machine learning model to reduce or minimize the distance between the points (e.g., until the points are within a threshold distance or a threshold similarity). Thus, not only does the transfer learning system 102 update parameters such that predicted data channel contributions are closer to expected data channel contributions, but the transfer learning system 102 further adjusts parameters such that predicted analytics metrics are closer to observed analytics metrics.

Implementing the iterative parameter update process of FIG. 4, the transfer learning system 102 learns model parameters that account for expected data channel contributions, predicted data channel contributions, observed analytics metrics, and predicted analytics metrics across a number of data channels and a number of time periods. Using the framework described in relation to FIG. 4, the transfer learning system 102 does not require the analytics prediction machine learning model or the data channel contribution function to take a specific forms. The transfer learning system 102 is therefore adaptable to many different model architectures, data channels, and campaign contexts.

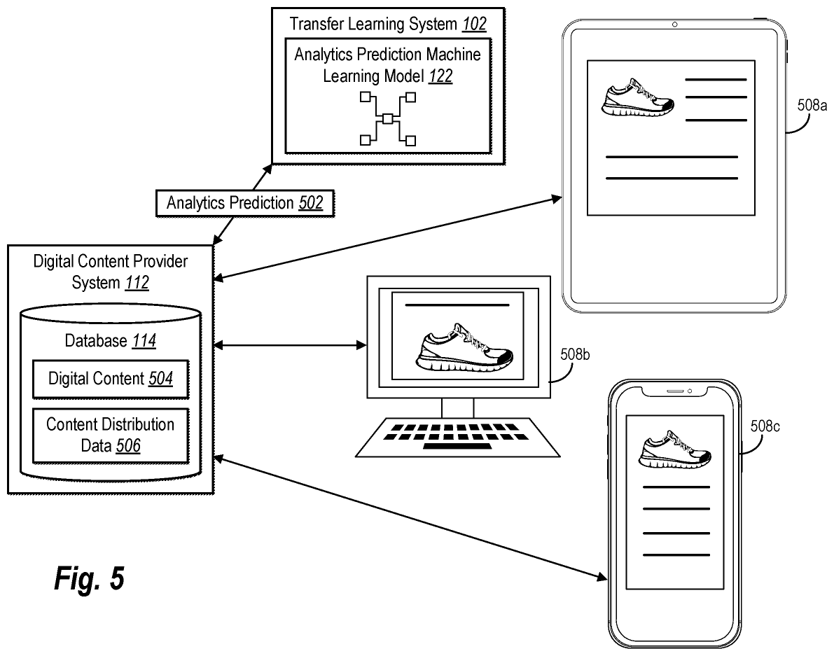

As mentioned above, in certain described embodiments, the transfer learning system 102 generates an analytics prediction utilizing an analytics prediction machine learning model. In particular, the transfer learning system 102 generates a prediction for a target analytics metric to inform a digital content provider system on how to distribute digital content for a digital content campaign. FIG. 5 illustrates an example diagram for generating an analytics prediction to utilize as a basis for distributing digital content in accordance with one or more embodiments.

As illustrated in FIG. 5, the transfer learning system 102 utilizes an analytics prediction machine learning model 122 to generate an analytics prediction 502. More specifically, the transfer learning system 102 utilizes the analytics prediction machine learning model 122 that includes parameters learned using the transfer learning processes described herein. To generate the analytics prediction 502, the transfer learning system 102 accesses content distribution data 506 associated with a digital content campaign. For instance, the transfer learning system 102 accesses or receives the content distribution data 506 stored within the database 114 of the digital content provider system 112. In some cases, the content distribution data 506 includes data regarding digital content to distribute, time periods for distribution, target audience information, and/or device information for recipient devices of the digital content. In one or more embodiments, the transfer learning system 102 determines a target analytics metric associated with the digital content campaign (e.g., from the content distribution data 506). Indeed, in some cases, the content distribution data 506 includes an indication of a target analytics metric that is the aim or goal of a digital content campaign (e.g., a certain conversion rate or a revenue amount).

From the content distribution data 506, the transfer learning system 102 generates the analytics prediction 502. More specifically, the transfer learning system 102 applies or implements the analytics prediction machine learning model 122 to process the content distribution data 506 according to its learned parameters. In turn, the analytics prediction machine learning model 122 generates an analytics prediction in the form of a predicted analytics metric of the same type indicated or designated by the target analytics metric. In some cases, the transfer learning system 102 generates multiple analytics predictions based on variations of the content distribution data 506 to, for example, test different content distribution scenarios to find particular digital content, time periods, and/or recipient devices (of a target audience) to distribute digital content to achieve a target analytics metric.

Based on the analytics prediction 502 (or the multiple analytics predictions), the transfer learning system 102 further causes or prompts the digital content provider system 112 to distribute digital content 504 to recipient devices as part of a digital content campaign. Indeed, the analytics prediction 502 informs the digital content provider system 112 on what digital content to provide to which recipient devices and when to achieve a target analytics metric. For instance, the digital content provider system 112 distributes digital content (e.g., web content relating to a particular product, such as a shoe) to a recipient device 508a, a recipient device 508b, and a recipient device 508c, each of different device types. To facilitate such distribution of digital content, the transfer learning system 102 generates different analytics predictions associated with each of the different device types, target audience information associated with the specific recipient devices, data channels for distributing the digital content, and/or distribution time periods. Accordingly, based on the analytics predictions generated via the analytics prediction machine learning model 122, the digital content provider system 112 distributes different variations of digital content via different data channels to different device types at different time periods to achieve a target analytics metric.

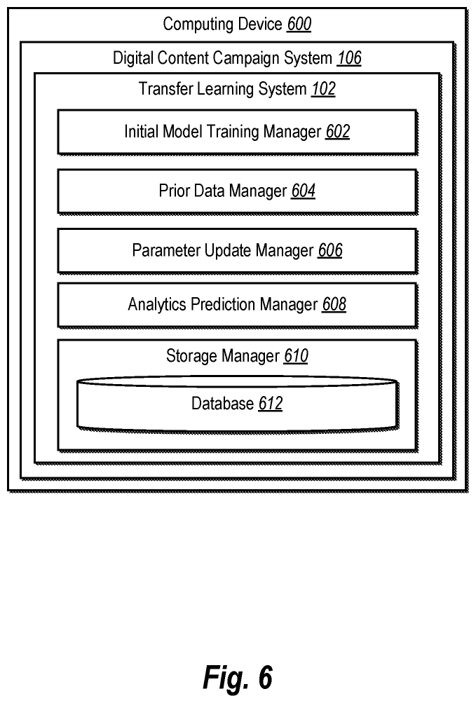

Looking now to FIG. 6, additional detail will be provided regarding components and capabilities of the transfer learning system 102. Specifically, FIG. 6 illustrates an example schematic diagram of the transfer learning system 102 on an example computing device 600 (e.g., one or more of the recipient device 108, the administrator device 116, the digital content provider system 112, and/or the server(s) 104). In some embodiments, the computing device 600 refers to a distributed computing system where different managers are located on different devices, as described above. As shown in FIG. 6, the transfer learning system 102 includes an initial model training manager 602, a prior data manager 604, a parameter update manager 606, an analytics prediction manager 608, and a storage manager 610.

As just mentioned, the transfer learning system 102 includes an initial model training manager 602. In particular, the initial model training manager 602 manages, maintains, determines, learns, generates, trains, tunes, or calibrates model parameters of an analytics prediction machine learning model. For example, the initial model training manager 602 utilizes a training process based on training data to adjust model parameters during an initial model building process.

As shown, the transfer learning system 102 also includes a prior data manager 604. In particular, the prior data manager 604 manages, maintains, stores, access, provides, determines, generates, predicts, or identifies prior data associated with a digital content campaign. For example, the prior data manager 604 determines an expected data channel contribution based on prior observed data. In some cases, the prior data manager 604 further determines a predicted data channel contribution using a data channel contribution function. The prior data manager 604 further compares a predicted data channel contribution with an expected data channel contribution.

As further illustrated in FIG. 6, the transfer learning system 102 includes a parameter update manager 606. In particular, the parameter update manager 606 manages, maintains, updates, determines, learns, modifies, tunes, adjusts, generates, or recalibrates model parameters according to a transfer learning process to account for expected and predicted data channel contributions. For example, the parameter update manager 606 utilizes the iterative update process described above to modify model parameters according to an object function.

Additionally, the transfer learning system 102 includes an analytics prediction manager 608. In particular, the analytics prediction manager 608 manages, determines, generates, predicts, or identifies an analytics prediction based on content distribution data. For example, the analytics prediction manager 608 utilizes content distribution data as an input for an analytics prediction machine learning model and applies the analytics prediction machine learning model to generate an analytics prediction for a target analytics metric.

The transfer learning system 102 further includes a storage manager 610. The storage manager 610 operates in conjunction with, or includes, one or more memory devices such as the database 612 (e.g., the database 114) that store various data such as model parameters, model training data, content distribution data, analytics metrics, and content data for distribution.

In one or more embodiments, each of the components of the transfer learning system 102 are in communication with one another using any suitable communication technologies. Additionally, the components of the transfer learning system 102 is in communication with one or more other devices including one or more client devices described above. It will be recognized that although the components of the transfer learning system 102 are shown to be separate in FIG. 6, any of the subcomponents may be combined into fewer components, such as into a single component, or divided into more components as may serve a particular implementation. Furthermore, although the components of FIG. 6 are described in connection with the transfer learning system 102, at least some of the components for performing operations in conjunction with the transfer learning system 102 described herein may be implemented on other devices within the environment.

The components of the transfer learning system 102, in one or more implementations, includes software, hardware, or both. For example, the components of the transfer learning system 102 include one or more instructions stored on a computer-readable storage medium and executable by processors of one or more computing devices (e.g., the computing device 600). When executed by the one or more processors, the computer-executable instructions of the transfer learning system 102 cause the computing device 600 to perform the methods described herein. Alternatively, the components of the transfer learning system 102 comprises hardware, such as a special purpose processing device to perform a certain function or group of functions. Additionally, or alternatively, the components of the transfer learning system 102 includes a combination of computer-executable instructions and hardware.

Furthermore, the components of the transfer learning system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the transfer learning system 102 may be implemented as part of a stand-alone application on a personal computing device or a mobile device. Alternatively, or additionally, the components of the transfer learning system 102 may be implemented in any application that allows creation and delivery of marketing content to users, including, but not limited to, applications in ADOBE® EXPERIENCE MANAGER and ADVERTISING CLOUD®, such as ADOBE ANALYTICS®, ADOBE AUDIENCE MANAGER®, and MARKETO®. “ADOBE,” “ADOBE EXPERIENCE MANAGER,” “ADVERTISING CLOUD,” “ADOBE ANALYTICS,” “ADOBE AUDIENCE MANAGER,” and “MARKETO” are either registered trademarks or trademarks of Adobe Inc. in the United States and/or other countries.

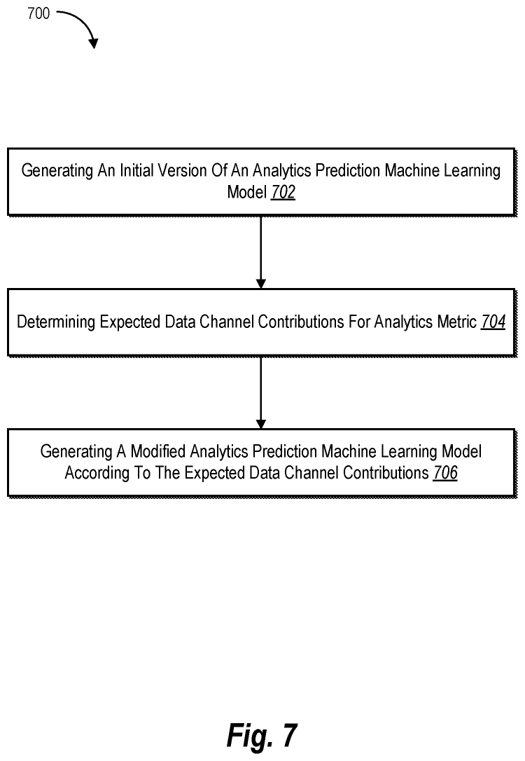

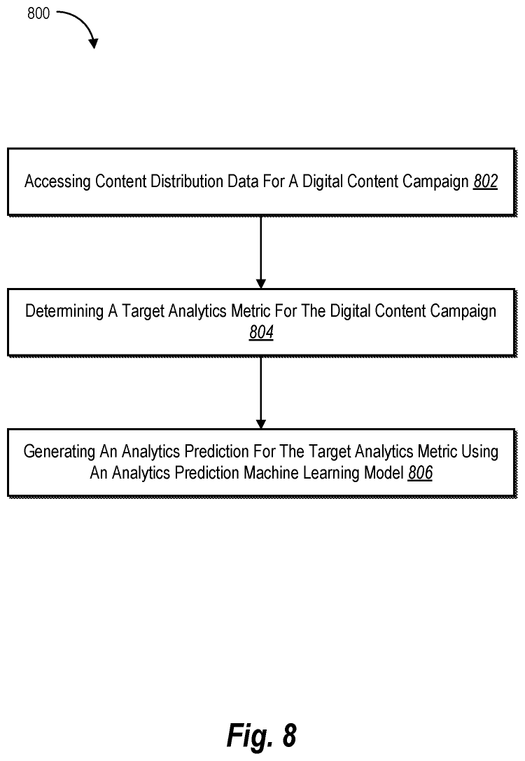

FIGS. 1-6 the corresponding text, and the examples provide a number of different systems, methods, and non-transitory computer readable media for generating, modifying, and applying an analytics prediction machine learning model based on a transfer learning approach. In addition to the foregoing, embodiments are describable in terms of flowcharts comprising acts for accomplishing a particular result. For example, FIGS. 7-8 illustrate flowcharts of example sequences or series of acts in accordance with one or more embodiments.

While FIGS. 7-8 illustrate acts according to particular embodiments, alternative embodiments may omit, add to, reorder, and/or modify any of the acts shown in FIGS. 7-8. The acts of FIGS. 7-8 are be performed as part of a method. Alternatively, a non-transitory computer readable medium comprises instructions, that when executed by one or more processors, cause a computing device to perform the acts of FIGS. 7-8. In still further embodiments, a system performs the acts of FIGS. 7-8. Additionally, the acts described herein may be repeated or performed in parallel with one another or in parallel with different instances of the same or other similar acts.

FIG. 7 illustrates an example series of acts 700 for generating a modified analytics prediction machine learning model using a transfer learning approach. In particular, the series of acts 700 includes an act 702 of generating an initial version of an analytics prediction machine learning model. For example, the act 702 includes generating an initial version of an analytics prediction machine learning model for predicting an analytics metric by learning parameters of the analytics prediction machine learning model utilizing model training data. In addition, the series of acts 700 includes an act 704 of determining expected data channel contributions for an analytics metric. For example, the act 704 includes determining expected data channel contributions for the analytics metric according to prior observed data. Further, the series of acts 700 includes an act 706 of generating a modified analytics prediction machine learning model according to the expected data channel contributions. For example, the act 706 includes generating a modified analytics prediction machine learning model by iteratively updating the parameters until the parameters, as used in a data channel contribution function, produce predicted data channel contributions that are within a threshold similarity of the expected data channel contributions. In some cases, the act 706 includes generating a modified analytics prediction machine learning model by iteratively: generating updated parameters from the expected data channel contributions, generating a point in parameter space representing the updated parameters utilizing a data channel contribution function, and comparing the point in parameter space with an additional point in the parameter space representing the expected data channel contributions.

In some embodiments, the series of acts 700 includes an act of generating the initial version of the analytics prediction machine learning model by learning the parameters from the model training data that includes digital content campaign data indicating content distribution and resulting analytics metrics for one or more digital content campaigns. In these or other embodiments, the series of acts 700 includes an act of determining the expected data channel contributions by accessing a database storing the prior observed data indicating respective contributions on impacting analytics metrics for a plurality of data channels.

In certain cases, the series of acts 700 includes an act of generating the modified analytics prediction machine learning model by iteratively updating the parameters by, for a number of iterations: generating the modified analytics prediction machine learning model by iteratively updating the parameters comprises, for a number of iterations, generating a point in parameter space representing the updated parameters utilizing the data channel contribution function, and comparing the point in the parameter space with an additional point in the parameter space representing the expected data channel contributions. In these or other cases, the series of acts 700 includes an act of generating the modified analytics prediction machine learning model by iteratively updating the parameters according to an objective function that incorporates the expected data channel contributions, the predicted data channel contributions, an observed analytics metric, and a predicted analytics metric generated according to the parameters.

In one or more embodiments, the series of acts 700 includes an act of generating the modified analytics prediction machine learning model by utilizing a surrogate function to modify terms of the data channel contribution function for iteratively updating the parameters. In some embodiments, the series of acts 700 includes an act of utilizing the surrogate function as part of updating the parameters of the analytics prediction machine learning model by replacing predicted analytics metrics of the data channel contribution function with observed analytics metrics.

In some cases, the series of acts 700 includes an act of determining the expected data channel contributions by determining the expected data channel contributions from the prior observed data indicating, for a plurality of data channels, respective contributions on impacting the analytics metric. In certain embodiments, the series of acts 700 includes an act of generating the modified analytics prediction machine learning model by iteratively updating the parameters, generating the point in the parameter space, and comparing the point in the parameter space with the additional point until the point and the additional point are within a threshold distance of each other in the parameter space.

In certain embodiments, the series of acts 700 includes an act of generating the modified analytics prediction machine learning model by iteratively updating the parameters according to an objective function that incorporates the expected data channel contributions, predicted data channel contributions, an observed analytics metric, and a predicted analytics metric generated by a previous version of the analytics prediction machine learning model according to a previous version of the parameters. In some cases, the series of acts 700 includes an act of generating the modified analytics prediction machine learning model by utilizing a surrogate function to iteratively update the parameters. In one or more embodiments, the series of acts 700 includes an act of utilizing the surrogate function as part of updating the parameters of the analytics prediction machine learning model by: determining a modified data channel contribution function by replacing predicted analytics metrics within the data channel contribution function with observed analytics metrics and generating the surrogate function to substitute for an objective function designed for updating the parameters of the analytics prediction machine learning model by utilizing the modified data channel contribution function.

FIG. 8 illustrates a series of acts 800 for generating an analytics prediction for a digital content campaign. In particular, the series of acts 800 includes an act 802 of accessing content distribution data for a digital content campaign. In addition, the series of acts 800 includes an act 804 of determining a target analytics metric for the digital content campaign. As further illustrated, the series of acts 800 includes an act 806 of generating an analytics prediction for the target analytics metric using an analytics prediction machine learning model. For example, the act 806 involves generating an analytics prediction for the target analytics metric utilizing the analytics prediction machine learning model to process the content distribution data according to the parameters learned from the iterative training process. In some embodiments, the analytics prediction machine learning model is stored in one or more memory devices and includes parameters learned from an iterative training process that includes updating the parameters over multiple iterations until the parameters, as used in a data channel contribution function, produce predicted data channel contributions that are within a threshold similarity of expected data channel contributions.

In some embodiments, the series of acts 800 includes an act of generating the analytics prediction for the target analytics metric by utilizing the analytics prediction machine learning model to generate a predicted conversion rate for the digital content campaign from the content distribution data. In some cases, the analytics prediction machine learning model includes parameters learned by iteratively: generating updated parameters from the expected data channel contributions, generating a point in parameter space representing the updated parameters utilizing the data channel contribution function, and comparing the point in the parameter space with an additional point in the parameter space representing the expected data channel contributions.

In one or more embodiments, the analytics prediction machine learning model includes parameters learned according to an objective function that incorporates the expected data channel contributions, predicted data channel contributions, an observed analytics metric, and a predicted analytics metric. In these or other embodiments, the objective function produces parameters for the analytics prediction machine learning model that reduce a difference between predicted data channel contributions and the expected data channel contributions. In some cases, the objective function includes a surrogate function that substitutes observed analytics metrics for predicted analytics metrics as a component of the objective function.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an example computing device 900 (e.g., the computing device 600, the recipient device 108, the administrator device 116, the digital content provider system 112, and/or the server(s) 104) that may be configured to perform one or more of the processes described above. One will appreciate that the transfer learning system 102 can comprise implementations of the computing device 900. As shown by FIG. 9, the computing device can comprise a processor 902, memory 904, a storage device 906, an I/O interface 908, and a communication interface 910. Furthermore, the computing device 900 can include an input device such as a touchscreen, mouse, keyboard, etc. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (HDD), flash memory, a Universal Serial Bus (USB) drive or a combination of these or other storage devices.

The computing device 900 also includes one or more input or output (“I/O”) devices/interfaces 908, which are provided to allow a user to provide input to (such as user strokes), receive output from, and otherwise transfer data to and from the computing device 900. These I/O devices/interfaces 908 may include a mouse, keypad or a keyboard, a touch screen, camera, optical scanner, network interface, modem, other known I/O devices or a combination of such I/O devices/interfaces 908. The touch screen may be activated with a writing device or a finger.

The I/O devices/interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating an initial version of an analytics prediction machine learning model for predicting an analytics metric by learning parameters of the analytics prediction machine learning model utilizing model training data;
determining expected data channel contributions for the analytics metric according to prior observed data; and
generating a modified analytics prediction machine learning model by iteratively updating the parameters until the parameters, as used in a data channel contribution function, produce predicted data channel contributions that are within a threshold similarity of the expected data channel contributions.

2. The computer-implemented method of claim 1, wherein generating the initial version of the analytics prediction machine learning model comprises learning the parameters from the model training data that includes digital content campaign data indicating content distribution and resulting analytics metrics for one or more digital content campaigns.

3. The computer-implemented method of claim 1, wherein determining the expected data channel contributions comprises accessing a database storing the prior observed data indicating respective contributions on impacting analytics metrics for a plurality of data channels.

4. The computer-implemented method of claim 1, wherein generating the modified analytics prediction machine learning model by iteratively updating the parameters comprises, for a number of iterations:
generating updated parameters from the expected data channel contributions;
generating a point in parameter space representing the updated parameters utilizing the data channel contribution function; and
comparing the point in the parameter space with an additional point in the parameter space representing the expected data channel contributions.

5. The computer-implemented method of claim 1, wherein generating the modified analytics prediction machine learning model comprises iteratively updating the parameters according to an objective function that incorporates the expected data channel contributions, the predicted data channel contributions, an observed analytics metric, and a predicted analytics metric generated according to the parameters.

6. The computer-implemented method of claim 1, wherein generating the modified analytics prediction machine learning model comprises utilizing a surrogate function to modify terms of the data channel contribution function for iteratively updating the parameters.

7. The computer-implemented method of claim 6, wherein utilizing the surrogate function as part of updating the parameters of the analytics prediction machine learning model comprises replacing predicted analytics metrics of the data channel contribution function with observed analytics metrics.

8. A non-transitory computer readable medium storing executable instructions which, when executed by a processing device, cause the processing device to perform operations comprising:
generating an initial version of an analytics prediction machine learning model for predicting an analytics metric by learning parameters of the analytics prediction machine learning model utilizing model training data;
determining expected data channel contributions for the analytics metric according to prior observed data; and
generating a modified analytics prediction machine learning model by iteratively:
generating updated parameters from the expected data channel contributions;
generating a point in parameter space representing the updated parameters utilizing a data channel contribution function; and
comparing the point in parameter space with an additional point in the parameter space representing the expected data channel contributions.

9. The non-transitory computer readable medium of claim 8, wherein generating the initial version of the analytics prediction machine learning model comprises learning the parameters from the model training data that includes digital content campaign data indicating content distribution and corresponding analytics metrics for one or more digital content campaigns.

10. The non-transitory computer readable medium of claim 8, wherein determining the expected data channel contributions comprises determining the expected data channel contributions from the prior observed data indicating, for a plurality of data channels, respective contributions on impacting the analytics metric.

11. The non-transitory computer readable medium of claim 8, wherein generating the modified analytics prediction machine learning model comprises iteratively updating the parameters, generating the point in the parameter space, and comparing the point in the parameter space with the additional point until the point and the additional point are within a threshold distance of each other in the parameter space.

12. The non-transitory computer readable medium of claim 8, wherein generating the modified analytics prediction machine learning model comprises iteratively updating the parameters according to an objective function that incorporates the expected data channel contributions, predicted data channel contributions, an observed analytics metric, and a predicted analytics metric generated by a previous version of the analytics prediction machine learning model according to a previous version of the parameters.

13. The non-transitory computer readable medium of claim 8, wherein generating the modified analytics prediction machine learning model comprises utilizing a surrogate function to iteratively update the parameters.

14. The non-transitory computer readable medium of claim 13, wherein utilizing the surrogate function as part of updating the parameters of the analytics prediction machine learning model comprises:
determining a modified data channel contribution function by replacing predicted analytics metrics within the data channel contribution function with observed analytics metrics; and
generating the surrogate function to substitute for an objective function designed for updating the parameters of the analytics prediction machine learning model by utilizing the modified data channel contribution function.

15. A system comprising:
one or more memory devices comprising an analytics prediction machine learning model comprising parameters learned from an iterative training process that includes updating the parameters over multiple iterations until the parameters, as used in a data channel contribution function, produce predicted data channel contributions that are within a threshold similarity of expected data channel contributions; and
one or more processors configured to cause the system to:
access content distribution data for a digital content campaign;
determine a target analytics metric for the digital content campaign; and
generate an analytics prediction for the target analytics metric utilizing the analytics prediction machine learning model to process the content distribution data according to the parameters learned from the iterative training process.

16. The system of claim 15, wherein generating the analytics prediction for the target analytics metric comprises utilizing the analytics prediction machine learning model to generate a predicted conversion rate for the digital content campaign from the content distribution data.

17. The system of claim 15, wherein the analytics prediction machine learning model comprises parameters learned by iteratively:
generating updated parameters from the expected data channel contributions;
generating a point in parameter space representing the updated parameters utilizing the data channel contribution function; and
comparing the point in the parameter space with an additional point in the parameter space representing the expected data channel contributions.

18. The system of claim 15, wherein the analytics prediction machine learning model comprises parameters learned according to an objective function that incorporates the expected data channel contributions, predicted data channel contributions, an observed analytics metric, and a predicted analytics metric.

19. The system of claim 18, wherein the objective function produces parameters for the analytics prediction machine learning model that reduce a difference between predicted data channel contributions and the expected data channel contributions.

20. The system of claim 18, wherein the objective function comprises a surrogate function that substitutes observed analytics metrics for predicted analytics metrics as a component of the objective function.
